(19) United States
(12) Patent Application Publication
(10) Pub. No.: US 2007/0241874 A1
(43) Pub. Date: Oct. 18, 2007

(54) Braking intensity light

(76) Inventors: Stephen L. Okpysh, Oceanside, CA (US); Gary H. Knapp, San Diego, CA (US)

Correspondence Address: Wesley B. Ames;Ames IP Law, 7031 Los Vientos Serenos, Escondido, CA, 92029, US

(21) Appl. No.: 11/405,985

(22) Filed: Apr. 17, 2006

(51) Int. Cl. B60Q 1/44

(52) U.S. Cl. 340/479

(57) ABSTRACT

Brake light control device is described that provides enhanced warning signals using stepped light intensity increases and/or flash rate indicative of braking level and/or determinations of hazard level posed by overtaking vehicles.

### RELATED APPLICATIONS

NOT APPLICABLE.

### FIELD OF THE INVENTION

The present invention relates to brake light controllers for motor vehicles.

### BACKGROUND OF THE INVENTION

The following discussion is provided solely to assist the understanding of the reader, and does not constitute an admission that any of the information discussed or references cited constitute prior art to the present invention.

A number of different brake light control systems have been described. For example, Stubock, U.S. Patent Publ. 2002/0158757, entitled “Vehicle Brake Light System” describes brake light systems, and states that “the brightness of the brake lights or the number of brakes lights illuminated depends on how far the brake pedal is depressed.” (Abstract)

Related U.S. patents Boyer et al., U.S. Pat. Nos. 6,720,871 and 6,943,677, both entitled “Modulated Intensity Flasher for Vehicle Brake Light with Lock-out” state that “a method and apparatus for brightening and dimming a brake light of automotive vehicle for enhanced display indication of braking includes a pulse width modulation unit to be electrically connected to a brake lamp for sequentially modulating the supply energy to the lamp to generate a brightening and dimming of the lamp.” (Abstract)

Rakow, U.S. Pat. No. 5,150,098 describes a system in which “dependable sequential pressure monitoring brake light display to alert others of the relative frequency and amount of braking force applied during baking of the vehicle.”

Voelker, U.S. Pat. No. 6,960,008, entitled “Proportional Brake Light Display System” concerns a “proportional brake light system” in which “the brake pedal shoe of the vehicle has a hollow interior, and an optical signal is transmitted along an optical transmission path extending therethrough. As the pressure supplied by operator to the pedal shoe is increased, more of the optical signal being transmitted along the optical transmission path is interrupted. A multi-stage comparator is responsive to an interruption of the optical signal so as to cause a corresponding number of LEDs from the display to be illuminated.” (Abstract)

Cohen et al., U.S. Pat. No. 6,573,830, entitled “Progressive Brake Light System” describes a system where there is “a brake sensor arranged to sense the travel of a brake pedal and a brake light display arranged to illuminate or extinguish in sequence or progressively in response to the travel of the brake pedal.” (Abstract)

Fenk, U.S. Pat. No. 6,100,799, entitled “Process and Device for Indicating Braking Power or Delay in Cars” describes a method and associated system involving “generating a signal which corresponds to the deceleration of the vehicle; displaying a lighted area on a display device including at least one brake light; and controlling the lighted area based upon said signal to vary at least one of a size, a position, a light intensity, and a color of said lighted area to correspond to a level of the deceleration.” (Col. 2, lines 26-32)

Two related patents, Carlson et al., U.S. Pat. Nos. 6,417,767 and 6,911,905, both entitled “Device and System for Indicating Rapid Deceleration in Vehicles” describe a “device that includes one or more sensors that are responsive to acceleration in the primary direction of vehicle motion” and “activates at least one warning indicator when the acceleration exceeds a threshold value and thereby indicates an urgent deceleration condition.”

Gao, U.S. Pat. No. 5,717,377 describes a “deceleration magnitude detecting and signaling device for alerting a driver of a following vehicle of the occurrence and magnitude of deceleration of a lead vehicle.”

Perez et al., U.S. Pat. No. 6,249,219 describes a system which is “designed to measure a vehicle's rate of motion and, upon deceleration of the vehicle, affect the vehicle's brake light circuit by switching it on and off at a rate proportion to the severity of the deceleration.”

### SUMMARY OF THE INVENTION

The present invention concerns advantageous brake light controllers that can be supplied for after-market or vehicle manufacturer installation. These controllers provide enhanced brake light signaling such that following cars are provided with additional information enable more rapid appropriate braking response by a following driver, thereby reducing the risk of collision.

Thus, in a first aspect, the invention concerns a vehicle brake light controller that includes a braking level sensor and a brake light modulator responsive to signals from that sensor. The modulator modulates (controls) intensity or pulse rate or both of at least one brake light. Such modulation occurs in discrete steps and the illuminated lights at each discrete step are the same. Thus, the controller does not require brake lights beyond the normal brake light complement to provide enhanced brake light signaling.

In certain embodiments, the modulation occurs in 2, 3, or 4 discrete steps; the discrete steps include discrete intensity levels; the discrete steps include different flash rates; the discrete steps include discrete intensity levels and different flash rates; the modulation includes different flash rates of a 3^{rd} brake light and not of primary brake lights; the modulation mode is selectable; modulation is inactivated below a pre-selected speed; modulation includes a recency lock-out; the modulation includes cycling of discrete intensity levels; the modulation persists for a selected interval following brief brake application.

In particular embodiments, the controller includes a self check system that inactivates the controller in the event a defect is detected such that a brake light(s) reverts to normal single-step on-off function; the braking level sensor includes a hydraulic line pressure sensor, a brake linkage sensor, a brake caliper pressure sensor, an ABS connection; an accelerometer.

In some embodiments, the modulation includes three discrete steps, where low light intensity corresponds to low braking level, slow flashing corresponds to intermediate braking level, and fast flashing corresponds to high braking intensity; or where low light intensity corresponds to low braking level, higher light intensity corresponds to intermediate braking level, and flashing corresponds to high braking level; or where low light intensity corresponds to low braking level, slow flashing at higher light intensity corresponds to intermediate braking level, and fast flashing with highest light intensity corresponds to high braking level; or where low light intensity corresponds to low braking level, higher light intensity corresponds to intermediate braking level, and flashing of third light only corresponds to high braking level; or where low light intensity corresponds to low braking level, flashing of third light at medium rate corresponds to intermediate braking level, and flashing of third light at fast rate corresponds to high braking level; or where steady light intensity corresponds to low braking intensity, slow flashing of third light corresponds to intermediate braking level, and fast flashing of third light corresponds to high braking level.

In certain preferred embodiments, the controller includes both LED and incandescent output connections; the controller has variable current output; the controller has multiple output resistor selections; flashing is indicative of high braking intensity, and only a third brake light is flashed; activation of an ABS system triggers flashing of at least one brake light, e.g., a central third brake light; application of a particular braking intensity results in sequential modulation of each discrete modulation corresponding to braking intensities up to the particular braking intensity.

In certain embodiments, the controller also includes at least one vehicle spacing sensor, where detection using the vehicle spacing sensor (e.g., based on radar (e.g., multi-beam radar) or low power laser of a trailing vehicle within a predetermined distance triggers flashing of at least one brake light and/or other rear light or text message. Such triggering can be locked out below a preselected speed and/or the predetermined distance can be a fixed distance, or can be a function of speed. Such distance detection can include calculation of rate-of-closing (e.g., using repeat determinations of distance) of the trailing vehicle and triggers modulation based on a combination of distance and rate of closing.

Detection and modulation based on distance and/or rate-of-closing may be combined in a system with modulation based on braking level and/or may be an independent system, which may be present in either the presence or absence of modulation based on braking level. Thus, another aspect of the invention concerns a rear vehicle light controller which includes a trailing vehicle distance sensor and a computer, where the computer calculates a trailing vehicle closing rate based on signals from the trailing vehicle distance sensor (e.g., a radar- and/or laser-based distance sensor). The controller also includes a rear vehicle light controller, where the controller modulates at least one rear vehicle light when the closing rate exceeds a threshold rate when the trailing vehicle is within a selected distance.

In particular embodiments, the modulation includes light flashing and/or light intensity modulation; the rear vehicle light includes a brake light, a fog light, a message light, any two or all three; the modulation involves light flashing which is stepped or graduated such that a higher flash rate corresponds to a greater collision risk, e.g., based on higher closing rate and closer distance.

In combination braking level and trailing vehicle determination systems, the light outputs for each of the two different types of input may be the same or different.

A related aspect concerns a brake light controller kit that includes a brake light controller, where the controller includes a braking level sensor and/or a trailing vehicle distance and/or closing rate sensor, a brake light modulator responsive to signals from the sensor(s) where the modulator modulates intensity or pulse rate or both of at least one brake light and the modulation occurs in discrete steps (and, in many cases, the illuminated lights at each discrete step are the same), and instructions for installing said brake light controller on a vehicle having brake lights or directions for obtaining such instructions.

In particular embodiments, the controller is as described for an above aspect or otherwise described herein.

In certain embodiments, the instructions are or include written instructions; video illustration; both written and video instructions; the controller and the instructions are packaged in one container; the directions are directions for obtaining on-line instructions.

A brake light controller can advantageously be provided configured as an add-on, or after-market unit. Such modular controller includes a braking level sensor and/or a trailing vehicle distance sensor, a brake light modulator responsive to signals from the sensor, where the modulator modulates intensity or pulse rate or both of at least one brake light and/or rear fog light and/or other rear vehicle light, and signal transmission circuitry that delivers illumination signals from said modulator to vehicle lights. The modulation occurs in discrete steps and, usually but not necessarily, the illuminated lights at each discrete step are the same. Such modular unit can be constructed for any vehicle, e.g., car, truck, or trailer (e.g., semi trailer).

In particular embodiments, the signal transmission circuitry is configured for connecting to a vehicle third brake light (e.g., of an automobile); the controller also includes an add-on brake light (e.g., for supplementing factory-installed brake lights); the controller includes at least one replacement light unit; the controller replaces and original light unit within an original light housing; the controller includes at least one LED replacement light adapted for replacement of an incandescent light in an original housing; the controller includes an illuminated text light (e.g., with a message such as “Danger”, “Too Close”, “Hazard”, and the like) the braking level sensor includes at least one accelerometer; the controller includes outputs for both LED and incandescent lights; the controller includes separate battery power; the controller is provided as a kit including instructions for installation and/or directions for obtaining such instructions.

In some embodiments, the controller is configured to replace a vehicle rear light unit (e.g., an LED light unit on a truck, or on a tractor or trailer of a semi, or on a truck or trailer of a truck and trailer combination), such as to fit within an existing light housing on the vehicle; such controller may include a light(s) and/or braking level modulator and/or rate of closing modulator (braking level and rate of closing modulators may be integrated in a combined modulator), and may also include additional components and features, such as event logging or connection for event logging and/or output for rear fog light and/or power input separate from switched brake connection. In particular embodiments, the controller is integrated with an LED light unit; the controller includes at least one (e.g., 1, 2, or 3) accelerometers; accelerometer detection of braking level is used to modulate brake lights in a pattern as described herein; a controller is linked with at least one additional light and/or additional controller providing co-modulation of the additional light(s); linkage of the controller utilizes wiring and/or radio-frequency linkage.

Similarly, rear vehicle light controllers (e.g., as described above or otherwise described herein) can be provided in kits or modular units similar to those described for the brake light controllers, which include the controller along with instructions for use and/or signal transmission circuitry.

Another aspect concerns a method for signaling braking level and/or trailing vehicle closing rate hazard, where the method involves activating a brake light modulator responsive to signals from a braking level sensor such that low braking intensity, medium braking intensity, and high braking intensity result in discrete, distinguishable illumination modulation, where the illuminated lights at each discrete illumination modulation are the same, and/or activating a brake light (and/or rear fog light and/or illuminated text message) modulator responsive to signals from a trailing vehicle distance and/or closing rate detector.

In particular embodiments, the brake light modulator is as described herein.

While the above description specifies modulation of brake lights, modulation can also be applied to other vehicle lights, for example, to one or more truck clearance lights and/or rear fog lights and/or illuminated text messages. Modulation of such other lights can be performed as the only modulation, or together with brake light modulation for at least some conditions

Likewise, modulation of vehicle brake lights and/or other vehicle lights can be triggered by use of an emergency brake and/or setting of a parking brake. This triggering can incorporate an override, e.g., such that a vehicle operator can turn off the modulation for a parked vehicle, especially one which will be parked for a long period of time and/or in a safe location. In some cases, the flashing is time limited, such that the flashing stops after a set period of time.

As used herein the term “ABS” or “ABS system” refers conventionally to a an anti-lock braking system in a vehicle. As commonly understood, ABS systems may include various other functions, including data recording functions.

The term “accelerometer” is used conventionally to refer to a device which is response to acceleration in at least one dimension, and in operation produces an output signal corresponding to such acceleration. In this context it is understood that deceleration is a special case acceleration (that is, an acceleration acting in a direction opposite to a particular velocity vector).

In the context of the present description, the term “brake light controller” refers to a system that modulates at least one brake light for a vehicle, or is designed for and will perform such modulation when installed.

The term “braking level sensor” means a device which responds to an input indicative of braking intensity (e.g., brake system hydraulic pressure, brake application force, or vehicle deceleration) and produces a signal corresponding to that braking intensity.

The term “brake light modulation” means a varying of at least one visible characteristic of brake light illumination, including, for example, brake light intensity and/or brake light flashing (which can include different flash rates). In the present context, a “brake light modulator” is a device, interconnected components, or sub-system of a brake light controller which creates the brake light modulation, e.g., produces varying electrical output which is or is intended to be directed to a brake light such that the brake light illumination is modulated.

In the context of a leading vehicle and a trailing vehicle, the term “closing rate” refers to the difference in speed of the vehicles when the trailing vehicle is traveling faster than the leading vehicle, i.e., the rate at which the trailing vehicle is overtaking the leading vehicle.

In reference to particular vehicle brake lights, the term “distal brake lights” refers to the brake lights (usually two) which are located at or near the lateral extremes of the rear of the vehicle; for automobiles such lights are distinct from the light normally referred to as the third brake light.

The term “event log” refers to a data recording system which stores or retains particular data during or in response to a predefined “event”, such as the occurrence of hard braking or a high hazard level due to a trailing vehicle being too close or closing at a high rate.

In the context of this invention, the term “hazard level” refers to a predefined measure of the risk of a vehicle accident. In most cases, the risk measure will be determined directly or indirectly according to a selected algorithm. Thus, in actual operation of a system utilizing hazard level, the hazard level may be determined in various ways, including, for example, implementation of the algorithm for each determination and/or utilization of a look-up table having elements corresponding to results from such algorithm. Alternatively, different hazard levels may be assigned without recourse to a particular express algorithm by assigning risk levels to particular operating conditions.

In connection with light from a vehicle brake light or other vehicle light, the term “intensity” refers to the light output level. The term “different intensities” means distinct light output levels which are readily visibly distinguishable.

In reference to modulation of illumination from a vehicle light, the term “modulation mode” means the type of visible change(s) in the light output from the vehicle light, e.g., the pattern of changes corresponding to different braking levels and/or different trailing vehicle hazard levels. In the context, the term “selectable” means that the modulation mode can be changed, preferably without replacing or adding to the components in a controller. Unless expressly indicated, use of the term “selectable” does not require that a vehicle operator be able to “select” a modulation mode during operation of the vehicle.

In the context of modulation of illumination from a vehicle light, the term “pulse rate” refers to the frequency of change of intensity of the light, e.g., on-off change, or bright-dim change.

As used, herein, the term “vehicle” includes all motor vehicles, specifically including cars and trucks, as well as trailers for towing behind such motor vehicles, including without limitation automobile trailers, truck trailers, and semi-truck trailers.

As used herein, the term “vehicle spacing sensor” refers to a device, set of interconnected components, sub-system, or system which detects the separation distance between two vehicles and produces an output signal corresponding to such distance. A vehicle spacing sensor may perform repeat separation distance determinations. Such repeat determinations may be used to determine a closing rate when a trailing vehicle is overtaking a leading vehicle.

Additional embodiments will be apparent from the Detailed Description and from the claims.

### BRIEF DESCRIPTION OF THE DRAWINGS

FIG. 1 shows a simplified schematic of an exemplary brake light controller that includes an accelerometer for sensing braking level.

FIG. 2 shows an operational flow schematic for an exemplary controller utilizing an accelerometer for sensing braking level.

FIG. 3 shows an operational flow schematic for an exemplary controller utilizing sensing of trailing vehicle distance and closing rate.

FIG. 4 shows an operational flow schematic for an exemplary controller that includes both deceleration detection and trailing vehicle rate of closure in modulation of brake and/or rear fog lights.

### DETAILED DESCRIPTION OF THE PREFERRED EMBODIMENTS

The present invention concerns a rear vehicle light controller (e.g., a brake light controller) that is adaptable to either aftermarket installation or installation by a vehicle manufacturer. The controller is suitable for using with conventional brake light configurations, e.g., single brake lights at outer rear of the vehicle, with a central supplementary third light, with an add-on brake light, with a rear fog light, and/or with other rear vehicle lights such as truck clearance lights. The controller responds to signals from a sensor or sensors that indicate the level of braking, e.g., pedal travel, braking effort (rather than simply brake pedal travel), or deceleration rate, and can include input from additional sensors, such as detection of wheel slip from an ABS system. Additional systems utilize trailing vehicle distance sensors in addition to or instead of braking level sensors.

It has been recognized that the usual brake lights only indicate that the brake pedal has been depressed, because the brake lights have only on and off states, and the on trigger responds either to light pressure or to mere pedal travel. The difficulty is that such brake signals do not provide any information on the actual braking level. For a following driver to determine the braking level, it is necessary for such following driver to mentally process additional visual cues, such as evaluating the rate of closing of the gap between the vehicles, the rate of growth of apparent size of the leading vehicle, and/or observing a change in the attitude of the leading vehicle.

Such additional observation and mental processing requires additional time, increasing the likelihood that the following driver will not react in sufficient time to avoid a collision when the leading driver brakes at a high level. This difficulty is exacerbated when driving conditions are adverse, because it becomes more difficult to quickly recognize and process the additional visual information needed to determine braking level.

Such additional information can be provided by the present controllers. While these controllers can be configured in various ways, they generally utilize discrete modulation steps. Such discrete steps are more readily noticed by a following driver than a continuous change. In addition, in many cases, it is beneficial for the controller to step through lighting conditions corresponding to any lower braking levels rather than going in a single step from off state to a lighted condition corresponding to the particular elevated braking level.

Braking Sensors

A number of different types and locations of sensors which send a signal corresponding to braking level can be used in the present controllers and kits. One type of sensor is a hydraulic line sensor. Hydraulic line pressure switches are commonly used for conventional brake light systems. Such a switch can be replaced or supplemented with a pressure sensor which provides an output signal that corresponds with the pressure, e.g., a proportional signal. Such a signal can be directed to the modulator, which determines what discrete modulation corresponds to that signal level and outputs the appropriate modulated power to cause illumination of the brake lights in accordance with the detected braking level.

Similar pressure detection can be performed at the brake pad. For example, a pressure sensor can be placed behind the caliper piston or between the pad and piston. The signal from such sensor can be used as above to drive the corresponding discrete modulated brake light illumination.

Also similarly, a brake linkage pressure sensor, e.g., pedal surface or push rod pressure sensor or pedal arm torque sensor, can be used to determine braking level. Such a sensor may a direct mechanical pressure sensor, or may be a strain or torque sensor. Such sensor may be combined similar to other pressure sensors to determine and produce the corresponding discrete modulated illumination.

In addition or instead of brake pressure sensors, a braking level can utilize a sensor detecting the rate at which the brake is applied as an indicator of braking level. For example, rapid brake application is indicative of emergency braking. Thus, a brake linkage rate sensor output signal can be directed to the modulator, translated to discrete modulation levels, and driving the modulated brake light illumination.

One modification of the present systems involves an ABS trigger, e.g., for detecting wheel slippage. Such wheel slippage is indicative of the highest braking level under the particular road and tire conditions. Therefore, such an ABS trigger functions as a detector and activator for highest braking level modulation. Such ABS trigger can be used to itself signal the highest braking intensity, or can be used as an override in conjunction with a pressure-based sensor/modulator combination. In such a system, a particular pressure corresponds to a brake light modulation that indicates a highest braking level. However, it is recognized that under adverse road conditions, the maximum vehicle slowing effect will occur with less braking pressure than under clean and dry road surface conditions. Under such conditions, the pressure-based system may produce a less than highest brake light modulation even though the braking effect is at maximum. Therefore, the ABS override trigger, detecting tire slippage, can cause the brake light modulation to shift to the highest level even if the pressure-based system would not otherwise result in such highest modulated illumination.

Instead of or in addition to a pressure-based system, accelerometers (detecting deceleration) may be used to determine braking levels. Because the maximum deceleration will depend on road and tire conditions (among others), an ABS trigger can also be usefully combined in such systems. With both an accelerometer and an ABS trigger, the ABS trigger can be used to detect the highest braking level and/or to override the signal from the other sensors to produce the highest level modulated brake light. The system may use a single accelerometer, or may use more than one.

For systems that incorporate an accelerometer to measure braking, or slowing rate, the system may have a signal threshold determination derived from a separate sensor type. Such separate sensor may be used, for example, to require initial brake application before the accelerometer signal will activate brake light modulation and/or require a minimum accelerometer signal before modulation is initiated.

In addition to or instead of braking level sensors, rear vehicle light controllers can incorporate trailing vehicle distance sensors, which can be linked with a computer to determine trailing vehicle closing rates.

Modulation Modes

A number of different brake light modulation modes may be utilized to provide additional information to following drivers. These modes can be selected to provide advantageous brake signaling and can include combinations of signal types. In addition, the controller can be designed such that any of a plurality of brake modulation modes can be selected for a particular installation. In most cases, the controller is designed to operate normally configured brake lights and so do not require multiple lights, e.g., for progressive illumination.

The different modes involve stepped light intensity and/or light pulsing.

Advantageously, embodiments of the present invention are capable of dual outputs, and thus are able to control either LED or incandescent brake lights. The incandescent brake light output simply uses normal voltage in the vehicle's electrical lighting system, but the LED output has the output voltage limited to control current through the LEDs to currents suitable for the particular LEDs. If the LED lighting unit(s) is supplied as part of a kit with the controller, then the controller LED output can be balanced for that LED lighting unit. If the controller is intended to function with any of a variety if different LED lighting units, then it can be advantageous to provide selectable (e.g. switchable) resistance to match the particular LED lighting unit with which the controller will be used.

Especially in, but not limited to, applications in which the present brake light controller is installed as an after-market item, the third brake light on most current automobiles is wired so that it is illuminated in the same manner as the standard distal brake lights. In certain controllers it is desirable to be able to control the third light differently, but running a separate wire for that light can be difficult. In such cases, the third light can be controlled using a remote sender/receiver pair, e.g., a radio frequency (rf) sender and receiver. The signal can be encoded such that triggering of the light from an extraneous source is extremely unlikely. (Such coding is commonly used, for example, in higher security garage door openers.) Thus, for example, a third light can be pulsed, without pulsing the other brake lights.

In certain designs, the system uses flashing or strobing of a differently colored light as a high braking level indicator. Such flashing or strobing can, for example, be used for high braking level and/or for emergency stop situations. Such differently colored light can be configured with the usual brake lights, but is preferably separated such that is easily distinguishable.

Distance Detector and Light Flasher

Certain of the controllers include components providing the additional function of detecting vehicles that are close behind, and flashing at least one brake light, fog light, or other rear vehicle light, e.g., flashing such lights for a short period. A detector for vehicle spacing can be based on available distance detectors, such as laser and/or radar sensors, preferably integrated with a computer that can determine a vehicle closing rate.

For example, a highly efficient distance measurement method is based on the flight time of a short, eye-safe laser pulse to the target and back. The principle is known as pulsed time-of-flight (TOF) distance measurement. Such a system can provide distance information, and using repeat determinations, can also calculate closing speed.

Likewise, a radar sensor can be used, such as the radar sensors currently used for adaptive (or active) cruise control. Such sensors are available, for example, from Bosch and from Continental (such as that used in certain Mercedes cars). An exemplary Adaptive Cruise Control (ACC) uses a three-beam radar sensor to monitor the road ahead of the car. These beams reflect off the vehicles ahead. Sensors pick up the reflection and the system immediately calculates the distance and can also calculate whether the car's speed needs to be adjusted, or if the road ahead is clear. This electronic eye monitors the road ahead of the car—up to 120 meters. When a car appears in the lane ahead, the system calculates its location, movement and relative speed, using the reflected radar waves.

Such system can be modified for use in the present brake light controller system. Rather than being directed forward, the radar can be directed rearward. The system can then calculate the distance to a trailing vehicle, and can also be configured to calculate closing speed, i.e., the speed difference for a trailing vehicle that is traveling faster.

In addition to (or instead of) linkage of the distance detection system with a braking sensor(s), the distance detection can be used directly to modulate one or more lights, e.g., as a warning to drivers following too closely. Such lights can be a particular warning display, e.g., text or symbols warning that the following vehicle is too close, and/or can be a modulation of normal vehicle lights, e.g., brake lights and/or clearance lights. Such distance warning can be particularly beneficial for use with trucks (e.g., large trucks such as semis or tractor-trailer trucks). Such distance detection and the resulting light signal or modulation can be linked to vehicle speed and/or a closing rate of a following vehicle, and can differ depending on how close the following vehicle is determined to be.

Thus, for example, the system can trigger a signal at a greater separation distance when the primary vehicle is traveling at normal highway speed, e.g., 50-70 mph than at significantly slower speeds. Similarly, the system can trigger a signal at a greater separation distance when the following vehicle is overtaking the primary vehicle at a substantial rate (e.g., a speed differential of 10-20, 20-30, or greater mph) as compared to a slower closing rate (e.g., less than 10, or 5 mph). Such signaling based on distance can be in coordination with or independent of a controller modulating lights based on sensing of braking or braking level.

Some such systems are configured such that the light modulation is graduated (either continuously or in stepped manner) to correspond with a collision risk as a function of both trailing vehicle distance and closing rate. As an illustration, the collision risk may be scaled with the inverse of the product of the trailing vehicle closing rate and trailing vehicle distance. Thus, the higher risk would be for close vehicles with high closing rate; moderate risks for distant vehicles at high closing rates, moderate distance vehicles at moderate closing rates, and close vehicles at low closing rates; and low risk for distant vehicles at moderate or low closing rates, moderate distances at low closing rates, and close vehicles at low closing rates. Of course many other scaling or weighting functions can be used for the collision risk. In many cases, the higher risk will correspond to light modulation at higher flash rates and/or higher intensity.

Systems incorporating such trailing vehicle distance sensors may incorporate a threshold distance such that no modulation will occur based on distance and/or closing rate unless the trailing vehicle is with a selected distance, which may be fixed or may depend on vehicle speed. Further, systems may include light modulation which acts as a tailgating warning, together with or instead of collision risk modulation. That is, the system can trigger light modulation if the trailing vehicle is within a specified distance, even if the closing rate is very low or even zero. Such specified distance can be fixed or can be scaled with the vehicle speed (e.g., proportional to the vehicle speed or expected braking distances). Advantageously, such tailgating modulation can be configurable; that is, the modulation can be altered or turned off if desired or required by government regulations or standards.

Another feature which can be incorporated in the present systems is driver notification of hazards relating to a trailing vehicle. Such notification may be particularly desirable for trucks and other commercial vehicles. The notification may be presented in various ways, and may include additional information. For example, when a particular hazard level is detected (e.g., due to a tailgating or rapidly overtaking trailing vehicle), a dash light can flash and/or a video feed (e.g., from a rear facing video camera) can be presented to the driver. Such notification and/or additional information can assist the driver in responding to the hazard situation.

Event Log

The present controllers also include a log of braking conditions and/or brake light or other vehicle light operation state. Such a log can be a critical event log (e.g., retain status information in the event of a collision or extreme braking, or can be a general event log which records braking level and/or brake and/or other light operation, e.g., over a particular time period, such as a 1, 2, 4, 8, 12, or 24 hour period. The particular data to be logged can be selected based on preferences suitable for a specific application. For example, the controller can log a time (which can be an hour clock time or a system time) and state for each state change. For example, on initial operation, the brake and brake light states may be off. When the brakes are applied for the first time, the time and braking level can be logged, with a new log entry recording the time when the brakes are released, and so on for each change. Less desirably due to the greater amount of memory required is periodically recording state data, e.g., recording the braking level and/or illumination state at 0.1-1.0 second intervals.

Such a log can be incorporated in a brake light controller, can be separate, or can be part of or connect with an ABS system or vehicle computer. In any case, the log will include instructions (which can be implemented in software and/or hardware) which direct recording of the selected information into memory, preferably non-volatile memory (so that the data is not erased when vehicle system electrical power is lost). The memory capacity is selected to be sufficient to hold the data intended to be recorded. The data can be organized in the memory in various ways. One such recording organization is a rolling First-In-First-Out (FIFO) manner. In this configuration, data is recorded over a selected time period or until the data memory dedicated to log data is full, at which point the controller writes over the oldest data with new data, continuing in this manner until all of the initial set of data is overwritten, and the cycle begins again. One variation is to record the data in blocks, which are written in progressive temporal manner. The blocks are then erased and/or rewritten in FIFO manner.

As indicated, the log can also be configured to retain data only if a collision or other crash event occurs. Typically such a log will respond to sensor data indicative of a crash, e.g., accelerometer output signals indicative of a crash as distinguished from braking. In such systems, the controller will log data continuously, but the data will be flushed, e.g., erased or overwritten, unless a collision is detected. If such collision is detected, a block of data preceding and/or during the collision is retained. Such retention can be accomplished in various ways, including, for example, by marking the data with a pointer or field value indicating the associated memory locations are not to be erased or overwritten, at least until the field value or pointer is changed to permit such operation. In the absence of detection of a collision event, the data flush can be performed with a number of different timings, e.g., periodically and/or upon vehicle shut-down or vehicle start-up.

In particular embodiments, the log will record data corresponding to at least 5, 10, 15, 20, or 30 minutes, or 1, 2, 3, 4, 6, or 8 hours of operation, or at least 10, 20, 50, 100, 200, 400, 700, 1000 braking level changes.

In addition to logging braking level and/or brake light illumination state changes, for a controller which includes a following vehicle sensor and light controller, the log can record data on following vehicles, e.g., distance, rate of closing, and/or speed. The data recording and retention configuration for such data can be organized similarly to the braking level and illumination state logging described above. Still further, the present data log can be incorporated into, or data combined with, other vehicle operation logs, e.g., logs recording vehicle speed, vehicle location, engine speed, engine conditions, and the like.

Data logs as described herein can be particularly desirable for heavy truck use. In such truck applications (as well as others), the log can be personalized, such that separate data is recorded for different vehicle operators. The different vehicle operators can be identified in any of a variety of ways, such as separate code or key entry on start-up, and/or the use of any of the various biometric identifiers (e.g., fingerprint or iris scanners).

Also particularly applicable to heavy truck application, the log can be configured to retain the data until downloaded, transmitted, or otherwise accessed, or cleared, either automatically or by operation initiated by a person. Downloads or data acquisition can, for example, be performed by removal of memory module(s), by direct electronic connection, or by wireless connection. Instructions for clearing data can also be transmitted to the controller by direct connection and/or by wireless connection.

In addition to logging braking level, deceleration data, and/or illumination data, the present systems can incorporate or be linked to video systems, e.g., video event recorders. For example, a controller can include or be linked with a video system such that actuation of the vehicle brakes at a very high level (or very high acceleration or deceleration) will cause the video system to retain video data, e.g., for a time period bracketing the high level braking or acceleration/deceleration. In particular, for controllers which include an accelerometer, data from the video system can be recorded and retained for each event during which high acceleration or deceleration was experienced. The magnitude and/or time characteristics of the acceleration/deceleration can be set at a level and/or signal analyzed to distinguish collisions. Advantageously, the video system is oriented to the rear of the vehicle, or to both the front and the rear. In some systems, the video system records video covering substantially all direction around the vehicle. The video system can also record scenes inside the vehicle. For systems in which video in lateral directions is recorded, advantageously the system includes at least one accelerometer oriented such that it effectively detects lateral acceleration.

In order to reduce the amount of memory required to hold the video data, the time interval for which video data is retained can be kept relatively short. For example, the video system may operate continuously with data recording. The recordings may be retained for the full operation interval, but in most systems, under normal conditions, the data will not be retained, but upon occurrence of an event or passing of a threshold, video data is retained in memory, typically from a time shortly before the event until a time shortly after the event. The bracketing times may be selected as desired, e.g., at least including video data from 5 sec before to 5 sec after, or 10 sec before to 10 sec after, or 30 sec before to 10 sec after, or 30 sec before to 15 sec after, or any combination of 5, 10, 15, 20, 30, 40, 50, or 60 sec before and 5, 10, 15, 20, 30, 40, 50, or 60 after. Other techniques known for reducing the amount of data for a particular time period can also be used separately or in combination, including, for example, reduced frame rates and video data compression.

Video event recorders (e.g., stand-along recorders) are available from DriveCam, Inc., San Diego, Calif. Such systems can be adapted or modified for integration in or with the present controllers. Such systems are described in the following set of related patents: Rayner, U.S. Pat. Nos. 6,389,340, 6,405,112, 6,449,540, and 6,718,239 all of which are incorporated herein by reference in their entireties.

Kits

In certain advantageous embodiments, the present brake light controllers (or other rear vehicle light controllers) are supplied in kits, especially for after-market (i.e., retro-fit) applications. Controllers in many such kit s are preferably designed such that the components can be tied into existing systems, without requiring additional wire runs to the brake lights (or other rear vehicle lights). The kits can be adapted for installation in vehicles with either LED or incandescent brake lights, utilizing the existing lights. Alternatively, the kit can be adapted for installing in a vehicle and use a light or lights supplied with the kit (or specifically adapted for use with the kit).

Such kits include a present controller and instructions for installation or directions for obtaining such instructions. Such instructions can be in the form of, or include, written instructions, pictorial instructions, and video instructions. Directions for obtaining instructions may be in written form; the instructions may be obtained by mail and/or via the internet.

Certain kits are, however, designed to include additional wire runs and/or connections. In some cases, transmitters and receivers (e.g., radio frequency transmitters and receivers are used). In addition, such kit can include a brake light (or fog light or other rear vehicle light) for mounting to the vehicle (or a trailer) that is modulated by the controller. Such light may be mounted as a supplement or replacement to an automobile third brake light, as an aftermarket third light for vehicles lacking such light, or as a trailer light to provide modulated braking indicator on a towed trailer.

In some cases, the controller is configured to supplement and/or replace a light unit on a vehicle (e.g., an LED light unit on a car, truck or trailer, such as a semi trailer). Thus, such a controller (which can be integrated with a light unit) can be designed to fit within an existing light housing on the vehicle. Advantageously, the controller is integrated with an LED light unit (e.g., substantially equivalent light output to the original vehicle light). The controller can include at least one (e.g., 1, 2, or 3) accelerometers. Multiple accelerometers can be used to provide redundancy (i.e., back-up function) and/or to distinguish different types of acceleration/deceleration), usually in conjunction with a microprocessor that analyzes signals from the various accelerometers. Such light replacement controller can modulate a brake light(s) in a modulation pattern or mode as described herein for other controllers. Such light replacement controller can further be linked with at least one additional light and/or additional controller providing co-modulation of the additional light(s). Such linkage can be performed in a number of different ways, e.g., utilizing existing and/or additional wiring and/or radio-frequency linkage.

In addition, or alternatively, such a light replacement controller can include a distance and/or rate of closing sensor and modulator. As indicated, such a controller is configured to replace a prior light unit (e.g., an LED light unit on a truck, such as a semi). The replacement can replace the entire light unit or can be sized and shaped to fit within an existing light housing on the vehicle, e.g., a standard light housing. Such a controller may include a light(s) (e.g., LED lights) and/or braking level modulator and/or distance or rate of closing modulator. Such braking level and distance or rate of closing modulators may be (and often will be) integrated in a combined modulator. Advantageously such light replacement controllers can include a connection(s) allowing connection with the wiring to the original light unit without modification. The controller may also include additional components and features, such as data logging (e.g., including one or more of braking level, illumination state, trailing vehicle distance and/or rate of closing), signal line or connection to an external data log, output for rear fog light and/or clearance lights, and/or power input separate from the switched brake connection. In addition, as described above, the controller may include a video recorder (e.g., a video event recorder) or include signal connections for such recorder. Advantageously, the data from a video recorder is recorded in register with data from the light modulator and/or accelerometer(s) so that a full record of the event is created and retained. The physical memory utilized for the different data may be the same or different, e.g., the light modulation system may utilize separate memory from a video event recorder, may record in the same physical memory but in distinct different addresses within that memory, or may record together with the video data (e.g., in similar manner as the recording of video and sound data in a conventional consumer digital video recorder).

Exemplary Controllers

Exemplary brake light controller and other rear vehicle light controller systems are illustrated with reference to the drawings.

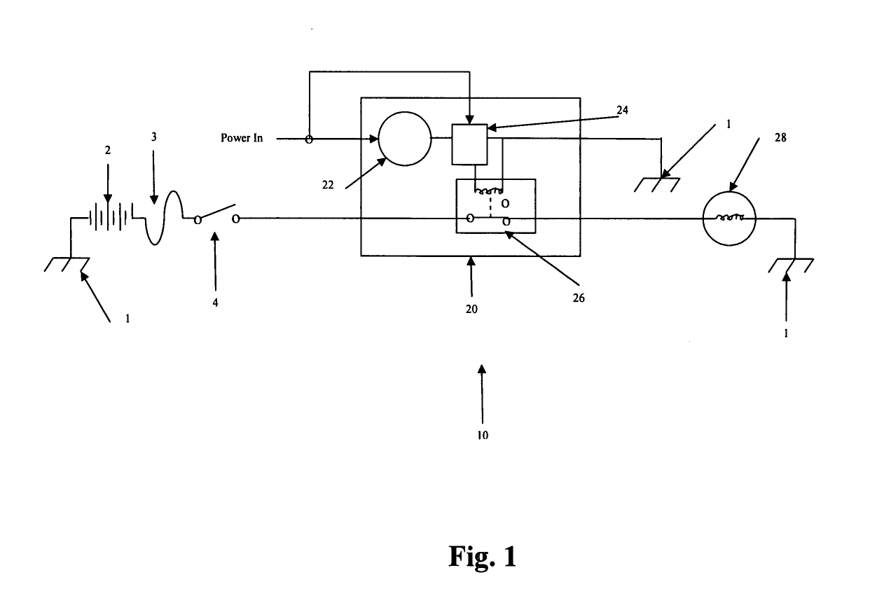

FIG. 1 shows a simplified circuit diagram for a brake light modulation system 10 that includes a controller 20 which has an accelerometer 22 to detect braking level by providing a signal indicative of deceleration. Electrical power is supplied from the vehicle battery 2, through fuse or breaker 3, and brake switch 4. Closing of the brake switch sends electricity for powering lights to the controller 20. In general, the controller 20 will be separately powered through a circuit actuated on vehicle start-up. Depending on the internal configuration of the controller, portions of the controller (e.g., volatile memory) may be constantly powered using battery and/or system power. Upon deceleration, the accelerometer sends a signal to timer/flash rate controller 24. The timer/flash rate controller determines whether the signal is indicative of a deceleration rate greater than a first threshold. Prior to operation of the brakes, the brake light(s) can be considered to be in state L0, i.e., no illumination. Upon engagement of the brakes, if the deceleration rate is below the first threshold, the third brake light and/or distal brake lights are illuminated at state L1 (e.g., normal light operation). If the deceleration rate is equal to or greater than the first threshold, but not greater than a second threshold, the light(s) are operated at state L2 (e.g., moderate flash rate). If the deceleration rate is greater than the second threshold, the light(s) are operated at state L3 (e.g., fast flash rate). Additional levels can also be used, but in many cases there will be 3 levels.

Upon release of the brakes such that the deceleration rate is reduced, the system resets to state L0. During engagement of the brakes, the deceleration state is repetitively monitored, such that the light operation state is updated at frequent intervals. Generally, however, the controller utilizes time averaging so that the light state remains stable for recognizable intervals. That is, a state L2 or L3 (or other state indicating braking above a first threshold) remains activated for a period sufficient for a following driver to recognize the elevated state, even if the braking level is reduced before the end of such recognition period. In the exemplary system illustrated in FIG. 1, the light(s) 28 are modulated through a normally closed relay 26. Thus, for state L1 the relay is closed such that power to the brake light(s) is uninterrupted. Initiation of state L2 or L3 causes the relay to open and close at the rates and for the durations selected for the respective states, controlled by the timer/flash rate controller.

Of course, it is understood that the illustrated circuitry is simplified, and that additional and/or alternative components can be included the brake light modulation systems. For example, the system may include resistors selected to limit current flow through LED brake lights. In certain systems, the system can advantageously include an input signal corresponding to vehicle speed (e.g., a signal such as is used to drive electronic speedometers), which can, for example, be used to provide a low speed lock-out. With such a low speed lock-out, the higher brake light states are blocked. Likewise, an input indicative of wheel slip can be used, e.g., from an ABS system. A wheel slip input can be beneficial to trigger an elevated brake light state even if the braking level (e.g., deceleration rate) is low. Such a condition may occur, for example, when a road surface is slick. Thus, an emergency condition can be detected and the corresponding brake light state initiated, even when the deceleration rate or other indicator of braking level is below the corresponding threshold. Other components and refinements, e.g., as indicated herein, can also be included.

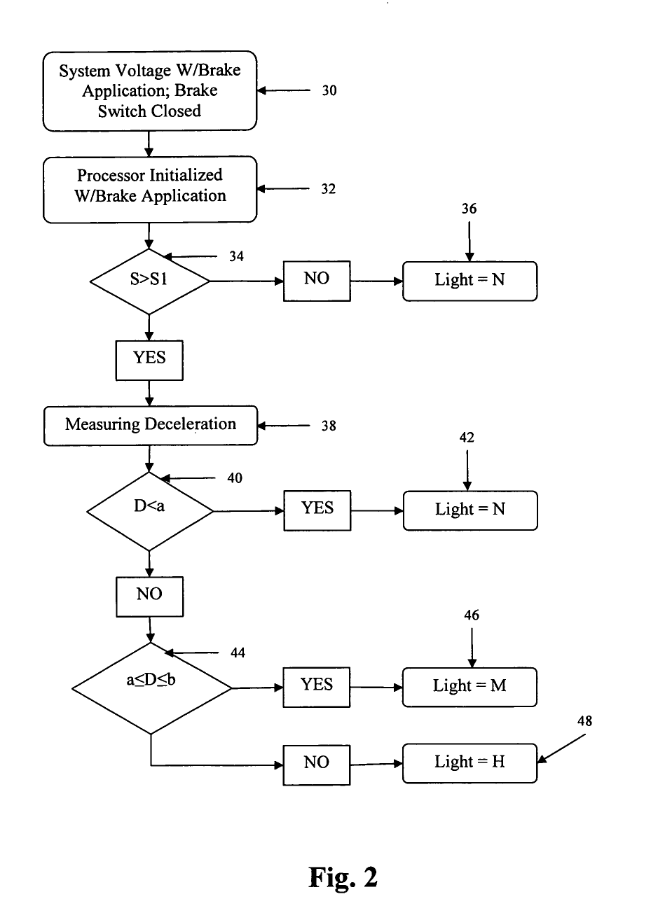

FIG. 2 shows an operational flow diagram for an exemplary system similar to that illustrated in FIG. 1, which includes an accelerometer to detect braking level. In the initial state box 30, system voltage is supplied on brake application, such that the light controller is initialized 32. A signal comparator determines whether the vehicle speed, S, is greater than a selected threshold S1 34. If S>S1 is NO, then the light(s) are operated at normal level N 36 (L1 from FIG. 1). If S>S1 is YES, then the deceleration, D, based on output from an accelerometer is determined 38. If D<a 40 is YES, then brake lights are illuminated at state N 42. If D<a is NO, then if a≦D≦b 44 is YES, then brake lights are illuminated at medium state M 46 (L2 from FIG. 1), but if a≦D≦b 44 is NO (i.e., deceleration is greater than threshold b), then brake lights are illuminated at high state H 48 (L3 from FIG. 1). To maintain the readability of the flow diagram, resetting, time averaging of illumination state, and re-determination of the braking level are not shown.

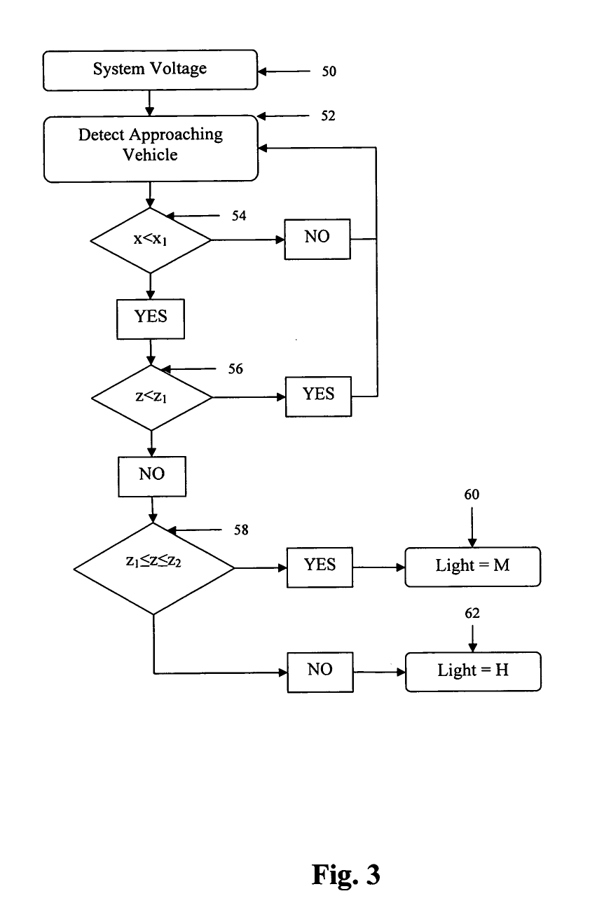

FIG. 3 shows an operational flow diagram for an exemplary system that utilizes a distance sensor to detect following vehicles that are within a selected distance and closing. Such a system can optionally incorporate modulation of rear fog lamps in addition to or instead of modulation of brake lights. As indicated above, such distance sensors can be implemented in various ways, including using sensors and processors of the type currently used for adaptive cruise control systems. In this system, power is supplied from the vehicle electrical system 50. During operation, the sensors continuously detect vehicles approaching from the rear 52. Such detection is processed to identify closing following vehicles, and to determine their separation distance, x, and closing rate, z. The controller will only actuate the lights if the closing vehicle is within a selected distance, which can vary as a function of closing speed. That is, the lights would be actuated at a greater separation distance for following vehicles that are closing at a greater rate. Thus, if x<x1 54 is NO, then no action is taken and the system continues with continuously determining the separation distance and closing rate. If x<x1 is YES, then if z<z1 56 is YES, no lights are actuated, but if NO (that is, z is equal to or greater than z1) and z1≦z≦z2 58 is YES, then lights are modulated at medium state M 60 (which may be the same or different than M in FIG. 2). However, if z1≦z≦z2 58 is NO (i.e., z is greater than z2), then lights are modulated at high state H 62 (which may be the same or different from state H in FIG. 2).

Thus, the system operates based on an evaluation of hazard from following vehicles. As indicated above, the values x1, z1 and z2 can be fixed values, or can be functions speed and/or other driving conditions. In a simple system, each of those values is a pre-determined fixed value. In operation, if a vehicle is with a fixed alert distance x1, if the closing rate is high enough so that a substantial but medium hazard exists, then the brake and/or rear fog lights are modulated at a medium level to communicate to the driver of the following vehicle that a medium hazard exists. If the closing rate is high, that indicates a high hazard level, so the lights are modulated at a high level, e.g., high flash rate and/or high intensity. Alternatively, if the threshold values are a function of closing speed, then the hazard level can more accurately correspond to the threshold values. For example, a vehicle which is close and closing at a low rate may represent the same hazard as one which is distant and closing at a high rate. Similarly, a vehicle which is close and closing at a moderate rate may represent a high hazard hazard, but a vehicle at a greater distance which is closing at a high rate may represent only a moderate hazard.

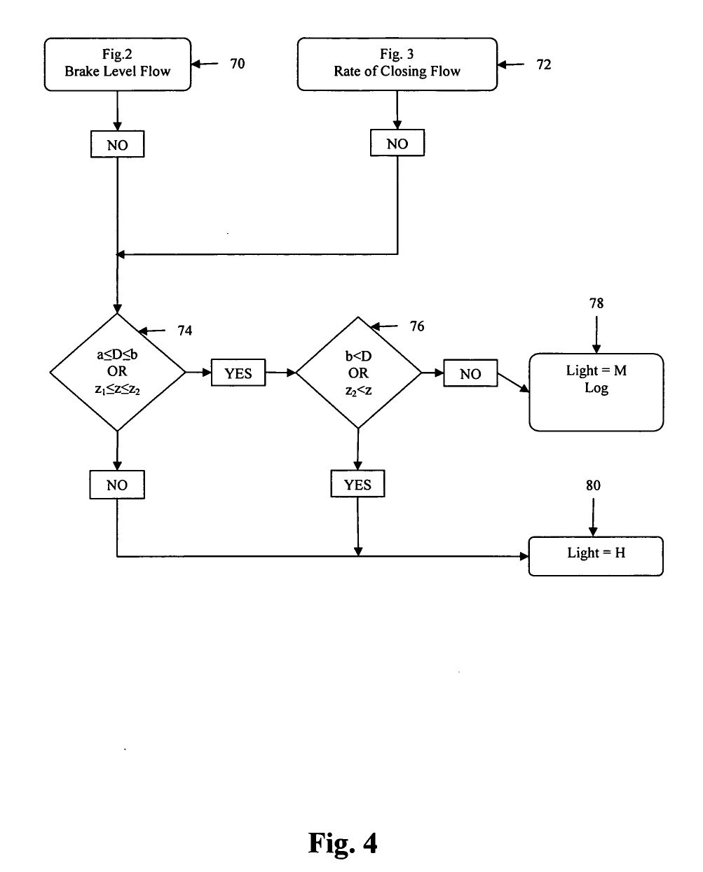

FIG. 4 shows an operational flow diagram for an exemplary system that combines both a controller including an accelerometer for sensing braking level as in FIG. 2, and a distance sensor for detecting following vehicles that are closing as in FIG. 3. The system flow should be viewed as including the initial portions of the flow from each of FIG. 2 and FIG. 3. Thus, in FIG. 4, FIG. 2 Brake Level Flow 70 corresponds to the decision point D<a 40 from FIG. 2, and FIG. 3 Rate of Closing Flow 72 corresponds to the decision point z<z1 56 from FIG. 3, with the FIG. 4 combined flow replacing the following NO branch portions of FIG. 2 and FIG. 3. Thus, if a≦D≦b OR z≦1z≦z2 74 is YES, it indicates at least a moderate hazard level (i.e., moderate or high hazard level). To distinguish between moderate and high hazard levels, a further comparison test is performed, thus, if b>D OR z2>z 76 is NO, then lights are modulated at illumination state M 78 (which can be the same or different for inputs indicating braking level (e.g., from a braking level controller sub-system) versus input indicating following vehicle closing rate hazard (e.g., from a following vehicle closing rate sub-system). On the other hand, if b>D OR z2>z 76 is YES, this indicates a high hazard and lights are modulated at high illumination state H 80, which can also be the same or different for inputs for braking level and for following vehicle closing rate. The high hazard condition can also be determined at the prior step, so if a≦D≦b OR z≦z≦z2 74 is NO, then lights are illuminated at high illumination state H, which again may be the same or different for inputs for braking level and for following vehicle closing rate. The NO result at this step indicates high hazard because if neither a≦D≦b OR z1≦z≦z2 is YES, then both conditions indicate high hazard and lights are illuminated at high state H. Essentially, the system determines whether either or both of the braking level and the closing vehicle rate indicates high hazard level, then the corresponding lights are illuminated at high level.

Of course, the system flows are only illustrative; systems can be configured in other ways, and incorporate a variety of different sensor and controller components.

All patents and other references cited in the specification are indicative of the level of skill of those skilled in the art to which the invention pertains, and are incorporated by reference in their entireties, including any tables and figures, to the same extent as if each reference had been incorporated by reference in its entirety individually.

One skilled in the art would readily appreciate that the present invention is well adapted to obtain the ends and advantages mentioned, as well as those inherent therein. The methods, variances, and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

It will be readily apparent to one skilled in the art that varying substitutions and modifications may be made to the invention disclosed herein without departing from the scope and spirit of the invention. For example, variations can be made to the type of braking sensor, location of control unit, and display modes. Thus, such additional embodiments are within the scope of the present invention and the following claims.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group.

Also, unless indicated to the contrary, where various numerical values or value range endpoints are provided for embodiments, additional embodiments are described by taking any 2 different values as the endpoints of a range or by taking two different range endpoints from specified ranges as the endpoints of an additional range. Such ranges are also within the scope of the described invention.

Thus, additional embodiments are within the scope of the invention and within the following claims.

1. A brake light controller, comprising
a braking level sensor;
a brake light modulator responsive to signals from said sensor, wherein said modulator modulates intensity or pulse rate or both of at least one brake light,
wherein said modulation occurs in discrete steps and the illuminated lights at each discrete step are the same.

2. The controller of claim 1, wherein said discrete steps are three discrete steps.

3. The controller of claim 1, wherein said modulation comprises discrete intensity levels.

4. The controller of claim 1, wherein said modulation comprises different flash rates.

5. The controller of claim 1, wherein said modulation comprises discrete intensity levels and different flash rates.

6. The controller of claim 1, wherein said modulation comprises different flash rates of a 3^{rd} brake light and not of primary brake lights.

7. (canceled)

8. The controller of claim 1, wherein said modulation is inactivated below a pre-selected speed.

9. (canceled)

10. (canceled)

11. (canceled)

12. (canceled)

13. (canceled)

14. The controller of claim 1, wherein said braking level sensor comprises an ABS connection.

15. The controller of claim 1, wherein said barking level sensor comprises an accelerometer.

16. The controller of claim 1, wherein said modulation comprises three discrete steps, wherein steady light intensity corresponds to low braking level, slow flashing corresponds to intermediate braking level, and fast flashing corresponds to high braking intensity.

17. The controller of claim 1, wherein said modulation comprises three discrete steps, wherein low, steady light intensity corresponds to low braking level, higher light intensity corresponds to intermediate braking level, and flashing corresponds to high braking intensity.

18. The controller of claim 1, wherein said modulation comprises three discrete steps, wherein steady light intensity corresponds to low braking level, slow flashing at higher light intensity corresponds to intermediate braking level, and fast flashing with highest light intensity corresponds to high braking intensity.

19. The controller of claim 1, wherein said modulation comprises three discrete steps, wherein low light intensity corresponds to low braking level, a higher light intensity corresponds to intermediate braking level, and flashing of a third light only corresponds to high braking intensity.

20. (canceled)

21. The controller of claim 1, wherein flashing is indicative of high braking intensity, and only a third brake light is flashed.

22. The controller of claim 1, wherein activation of an ABS system triggers flashing of at least one brake light.

23. (canceled)

24. The controller of claim 23, wherein said sequential modulation is repeated continuously for the highest level of braking intensity.

25. The controller of claim 1, further comprising a vehicle spacing sensor, wherein detection of a trailing vehicle within a predetermined distance triggers flashing of at least one brake light and wherein said triggering is locked out below a preselected speed.

26. The controller of claim 25, wherein said predetermined distance is a function of vehicle speed.

27. The controller of claim 1, further comprising a vehicle spacing sensor and a computer that determines closing rate for a following vehicle and triggers modulation corresponding to the highest braking intensity or an emergency modulation for closing rates greater than a threshold rate for vehicles within a selected distance.

28. The controller of claim 27, wherein said selected distance is a function of vehicle speed or closing rate, or both.

29. The controller of claim 1, further comprising an output for controlling rear fog lights.

30. The controller of claim 28, wherein said modulation for closing rates greater than a threshold rate includes modulation of rear fog lights.

31. A rear vehicle light controller, comprising
a trailing vehicle distance sensor and a computer, wherein said computer calculates a trailing vehicle closing rate based on signals from said trailing vehicle distance sensor;
a rear vehicle light controller, wherein said controller modulates at least one rear vehicle light when said closing rate exceed a threshold rate when said trailing vehicle is within a selected distance.

32. The controller of claim 31, wherein said modulation comprises light flashing.

33. The controller of claim 31, wherein said rear vehicle light comprises a brake light.

34. The controller of claim 31, wherein said rear vehicle light comprises a fog light.

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)
